(19) United States
(12) Patent Application Publication
(10) Pub. No.: US 2022/0279423 A1
(43) Pub. Date: Sep. 1, 2022

(54) SYSTEMS AND METHODS FOR EFFICIENT AND RELIABLE CELL BROADCASTING IN TREE-BASED WIRELESS NETWORKS

(71) Applicant: JUGANU LTD., Rosh Haain (IL)

(72) Inventors: Pinchas ZIV, Rosh Haain (IL); Reuven COHEN, Rosh Haain (IL); Eran BEN-SHMUEL, Rosh Haain (IL); Alexander BILCHINSKY, Rosh Haain (IL)

(21) Appl. No.: 17/748,260

(22) Filed: May 19, 2022

Related U.S. Application Data
(63) Continuation of application No. 17/095,406, filed on Nov. 11, 2020, now abandoned.
(60) Provisional application No. 62/933,626, filed on Nov. 11, 2019.

(51) Int. Cl. H04W 40/24; H04L 5/00; H04L 45/16; H04L 45/48

(52) U.S. Cl. CPC H04W 40/248; H04L 5/0055; H04L 45/16; H04L 45/48

(57) ABSTRACT

Approaches for routing a packet in a network having multiple cells each comprising a parent node and one or more child nodes include establishing and storing an identifier table including one or more link identifiers associated with the child node(s); upon receiving the packet, generating a string of one or more bits based at least in part on the link identifier(s); and transmitting the packet and the generated string to the child node(s).

### CROSS-REFERENCE TO RELATED APPLICATION

This application claims priority to and the benefit of U.S. Provisional Application No. 62/933,626 filed on Nov. 11, 2019, the entire disclosure of which is hereby incorporated by reference.

### TECHNICAL FIELD

The present invention relates generally to tree-based wireless networks, and in various embodiments more specifically to approaches for efficiently and reliably broadcasting a multicast packet in such networks.

### BACKGROUND

Recent developments in Internet and mobile communication technologies provide diverse multimedia services, which may be delivered almost instantaneously over vast distances. The proliferation of compact portable electronic devices such as notebook computers, mobile phones and tablets have necessitated deployment of such services, which tend to be very data-intensive, over wireless networks.

One commonly used wireless network has a tree-based structure. This network architecture is often deployed in device networks organized or governed by controllers. For example, tree-based wireless networks are often used when a controller controls a group of network members (or “nodes”); each group member will be reachable via a path across the wireless tree, enabling a point-to-multipoint communication (P2MP) (such as from the controller to some or all of the nodes) and multipoint-to-point communication (MP2P) (such as from some or all of the nodes to the controller). Common applications include controlled lighting systems, city-wide automatic meter-reading systems, and other municipal and commercial device networks.

The wireless network may use various random-access algorithms to access the wireless channels. For example, a “carrier-sense multiple access with collision avoidance” (CSMA/CA) algorithm may be used to access a radio channel for packet delivery (in accordance with, e.g., the IEEE 802.15.4 and 802.11 standards). In addition, a root-originated group packet may be delivered in the tree network using various approaches. For example, referring to FIG. 1A, one conventional approach for delivering a packet containing a target group identifier and packet payload from a tree root to a target group is to “flood” the entire tree and broadcast the packet to all nodes thereon. Each node, upon receipt of the broadcast packet, may re-broadcast the received multicast message. But because no automatic request repeat (ARQ) procedure is employed—i.e., no usage of medium access control (MAC) acknowledgments (ACKs), broadcasting the packet utilizing standard MAC protocols (e.g., IEEE 802.11 and 802.15.4) may be unreliable as some packets may not reach the target group of nodes.

Another conventional approach for delivery of a packet from the tree root to the target group is by individual unicasting. For example, referring to FIG. 1B, the root may generate (or receive from a network-management system) a unicast message containing a target multicast group identifier. Because unicasting generally applies the ARQ procedure in standard MAC protocols, all nodes along the path(s) to the target node(s) deliver the message as a unicast message with acknowledgement. As a result, the probability that the message will reach the target node is higher than with unacknowledged delivery via broadcasting. But this approach has its own deficiencies. For example, when a node transmits a packet to a group of N nodes associated therewith in the tree network, at least N unicast packets with N acknowledgements have to be delivered to the group of nodes; such a scheme increases the packet load and is wasteful of network resources. The situation may be aggravated when delivery fails, as each node that failed to receive the packet may require unicast redelivery.

Another conventional approach for delivery of a packet is by multicasting. For example, referring to FIG. 1C, multicast delivery may be performed via unicasting followed by broadcasting. As depicted, the root node 112 first delivers the message to the “first” node 114 via unicasting; subsequently, the node 114 broadcasts the message to the sub-trees 116, 118 containing the target group members therebelow. As used herein, the term “first node” refers to the node that receives messages via unicasting. While multicast approaches may effectively save network bandwidth, like broadcast they do not employ the ARQ procedure in standard MAC protocols; thus, some packets may not reach one or more members of the targeted group of nodes. In many situations, such as systems that control a group nodes using a command (e.g., lighting systems) or those involving selective information collection (e.g., sensor systems), it is, however, required to deliver a tree-root-initiated command/packet to the targets (e.g., all tree nodes or the tree nodes that belong to the target group and/or are on the path to the target group) efficiently and reliably.

Accordingly, there is a need for approaches that can efficiently and reliably deliver packets to a target group of nodes in a tree-based wireless network.

### SUMMARY

The present invention relates to approaches for efficiently and reliably delivering a packet to a target group of nodes in a tree-based wireless network by using a broadcast-with-ARQ frame that includes the packet and a string of bits; each bit in the string corresponds to a link identifier of a child node to which the parent node transmits the packet. In various embodiments, the parent node creates the link identifier and transmits it to the child node, e.g., for storage in a database of or associated with the child node. Upon receiving a packet, the parent node may generate the string of bits based on the link identifiers of the child nodes to which the packet is transmitted. For example, the most significant bit (MSB) position in the generated string may correspond to the highest number of the link identifiers; as the bit position moves away from the MSB, the corresponding number of the link identifier may decrease until the least significant bit (LSB) position corresponds to the lowest number of the link identifier. The parent node may then transmit the packet and the string of bits via the broadcast-with-ARQ frame in the MAC layer to its associated child nodes.

In some embodiments, upon receipt of the broadcast-with-ARQ frame, the child nodes may retrieve their link identifiers from the databases and process the frame to acquire the binary values in the bit positions associated with their link identifiers. If the bit values are zero (i.e., “CLEAR”), the child nodes are not required to respond with acknowledgments (ACKs) to the parent nodes. If, however, the bit values are non-zero (i.e., “SET”), the child nodes are required to report the ACKs to the parent node. In one embodiment, each child node determines its reporting time of the response ACK based on its corresponding bit position in the string and an ACK duration (which is defined by the transmission duration of the ACK and the time interval between successive ACKs). Subsequently, each child node can report the ACK to the parent node at the computed reporting time. Thereafter, each child node may act as a parent node to create a string of bits based on the link identifiers of its associated child nodes and deliver the received packet and the created string of bits via a new broadcast-with-ARQ frame to its associated child nodes (or a selected group of its child nodes). This procedure may be implemented by the network nodes along the path to the target node(s).

Accordingly, various embodiments herein may efficiently deliver the packet from the parent node to all of its associated child nodes in a broadcasting manner (or to a selected group of child nodes in a multicasting manner). In addition, because the child nodes can determine whether and when to report the ACKs to the parent node based on the bit positions associated with their link identifiers in the string, the parent node can easily identify the child nodes that should have but did not receive the packet and, based thereon, retransmit the packet thereto (e.g., using the ARQ procedure in a unicasting manner). Thus, approaches described herein may reliably deliver the packet to the target group of nodes in the wireless tree network.

Accordingly, in one aspect, the invention pertains to a method of routing a packet in a network having multiple cells each supporting communication among multiple transceiver nodes therein and being capable of receiving and transmitting the packet; each cell includes a parent node and one or more child nodes. In various embodiments, the method includes (a) for each cell, establishing and storing an identifier table having one or more link identifiers associated with the one or more child nodes; (b) upon receiving a packet, generating a string of one or more bits based at least in part on the link identifier(s); and (c) transmitting the packet and the string to the child node(s). In one implementation, the pack and the string in step (c) are transmitted in a broadcasting manner. In addition, the method may further include receiving ACK(s) from the child node(s). The child node(s) may transmit the ACK(s) only when the value(s) of the bit(s) is non-zero.

In various embodiments, one or more of the cells include multiple child nodes and each of the identifier tables in these cells includes multiple link identifiers, each associated with one of the child nodes; in addition, the string generated in step (b) includes multiple bits, each corresponding to one of the link identifiers. In one embodiment, the most-significant bit (MSB) position in the string corresponds to the highest number of the link identifiers, and as the bit position moves away from the MSB, the corresponding number of the link identifier decreases. In addition, the method may further include receiving at least some ACKs from at least some of the child nodes; each of the child nodes transmits the ACK at a transmitting time based at least in part on the bit position associated with its link identifier in the string. In one implementation, the transmitting time associated with each of the child nodes is further based at least in part on a transmission duration of the ACK and a time interval between two successive ACKs. For example, the transmitting time associated with each of the child nodes may satisfy an equation:

transmitting time=(t+Δt)×K

where t denotes the transmission duration of the ACK, Δt denotes the time interval between two successive ACKs, and K denotes a number of bits having non-zero values and preceding the bit position associated with each corresponding child node in the string. In addition, the method may further include, upon determining that the ACK from one of the child nodes is not received at the transmitting time associated therewith, retransmitting the packet to the child node.

In another aspect, the invention relates to a router for handling packets in a network. In various embodiments, the router includes memory for storing an identifier table having multiple link identifiers and multiple child nodes, each of the link identifiers being associated with one of the child nodes of the router; and a routing module configured to (a) upon receiving a packet, generate a string of one or more bits based at least in part on one or more of the link identifiers; and (b) transmit the packet and the string to the child node(s) associated with the link identifier(s). In one implementation, the routing module is further configured to transmit the pack and string in a broadcasting manner.

In addition, the routing module may be further configured to receive an ACK from the child node. In one embodiment, the child node transmits the ACK only when a value of the bit associated therewith is non-zero. In some embodiments, the string generated in step (a) includes multiple bits, each corresponding to one of the link identifiers. The MSB position in the string may correspond to the highest number of the link identifiers, and as the bit position moves away from the MSB, the corresponding number of the link identifier may decrease. In addition, the routing module may be further configured to receive at least some ACKs from at least some of the child nodes; each of the child nodes transmits the ACK at a transmitting time based at least in part on the bit position associated with its link identifier in the string. Further, the transmitting time associated with each of the child nodes may be further based at least in part on a transmission duration of the ACK and a time interval between two successive ACKs. For example, the transmitting time associated with each of the child nodes may satisfy an equation:

transmitting time=(t+Δt)×K

where t denotes a transmission duration of the ACK, Δt denotes the time interval between two successive ACKs, and K denotes a number of bits having non-zero values and preceding the bit position associated with the corresponding child node in the string. In some embodiments, the routing module is further configured to, upon determining that the ACK from one of the child nodes is not received at the transmitting time associated therewith, retransmit the packet to the child node.

Another aspect of the invention relates to a network system for routing a packet in a network having multiple cells each supporting communication among multiple transceiver nodes therein and being capable of receiving and transmitting the packet; each cell includes a parent node and one or more child nodes. In various embodiments, the system includes memory for storing an identifier table having one or more link identifiers associated with the one or more child nodes; and one or more network management systems associated with one or more of the transceiver nodes. The network management system(s) may be configured to (a) upon receiving a packet, generate a string of one or more bits based at least in part on the link identifier(s); and (b) transmit the packet and the string to the child node(s). In one implementation, the network management system(s) is further configured to transmit the pack and string in a broadcasting manner. In addition, the network management system(s) may be further configured to receive ACK(s) from the child node(s). The child node(s) may transmit the ACK(s) only when the value(s) of the bit(s) is non-zero.

In various embodiments, one or more of the cells include multiple child nodes and each of the identifier tables in these cells includes multiple link identifiers, each associated with one of the child nodes; in addition, the string generated in step (a) includes multiple bits, each corresponding to one of the link identifiers. In one embodiment, the most-significant bit (MSB) position in the string corresponds to the highest number of the link identifiers, and as the bit position moves away from the MSB, the corresponding number of the link identifier decreases. In addition, the network management system(s) may be further configured to receive at least some ACKs from at least some of the child nodes; each of the child nodes transmits the ACK at a transmitting time based at least in part on the bit position associated with its link identifier in the string. Further, the transmitting time associated with each of the child nodes may be further based at least in part on a transmission duration of the ACK and a time interval between two successive ACKs. For example, the transmitting time associated with each of the child nodes may satisfy an equation:

transmitting time=(t+Δt)×K

where t denotes a transmission duration of the ACK, Δt denotes the time interval between two successive ACKs, and K denotes a number of bits having non-zero values and preceding the bit position associated with the corresponding child node in the string. The network management system(s) may be further configured to, upon determining that the ACK from one of the child nodes is not received at the transmitting time associated therewith, retransmit the packet to the child node.

Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIGS. 1A-1C depict various conventional approaches for delivery of a packet from a root node to a target group of nodes in a tree-based wireless network;

FIG. 2 conceptually illustrates an exemplary tree-based wireless network having multiple network nodes in accordance with various embodiments;

FIG. 3 conceptually depicts an identifier table including a list of link identifiers and optional MAC addresses corresponding to the child nodes of a parent node in accordance with various embodiments;

FIG. 4 conceptually depicts an exemplary string of bits contained in a broadcast-with-ARQ frame for representing the child nodes of a parent node in accordance with various embodiments; and

FIG. 5 is a flow chart illustrating an exemplary approach for efficiently and reliably delivering a packet to a target group of nodes in a tree-based wireless network in accordance with various embodiments.

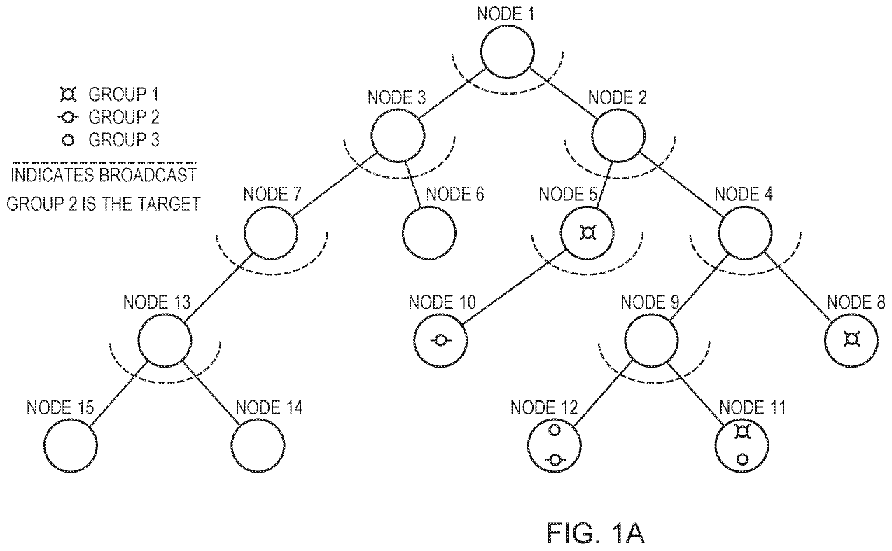

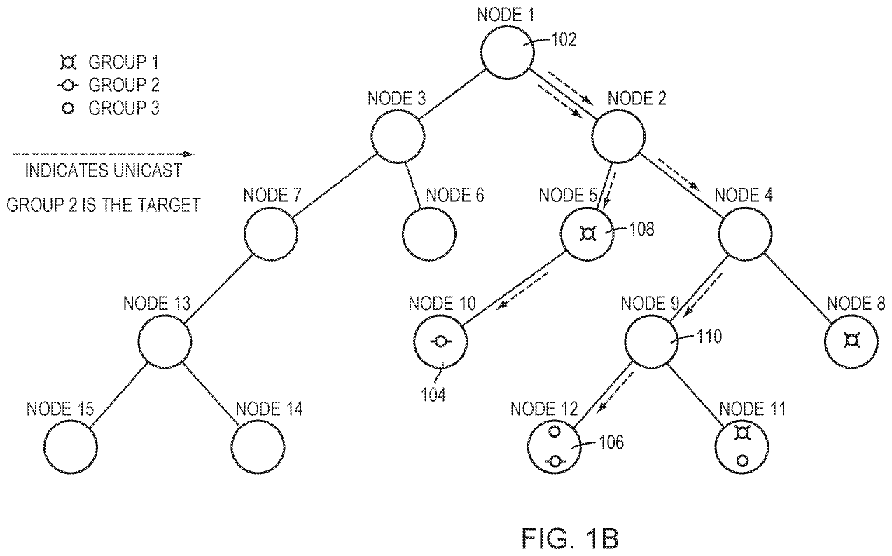

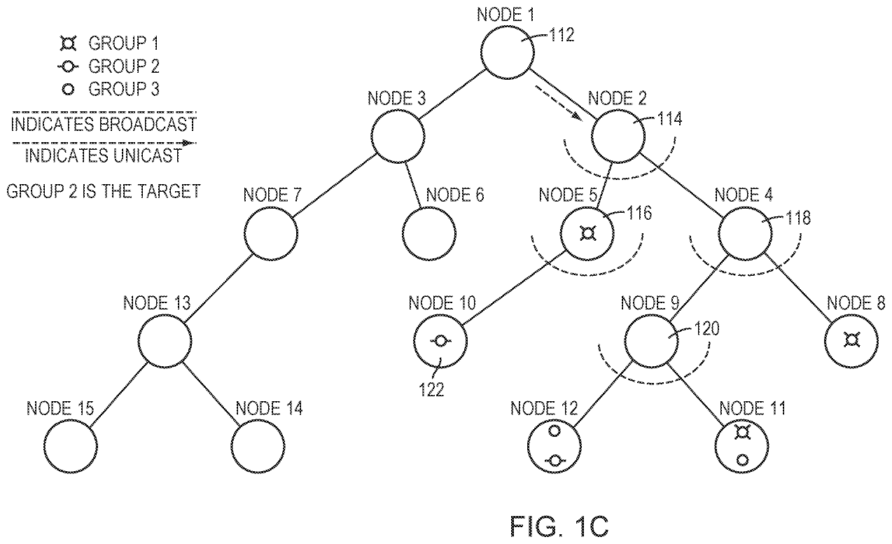

### DETAILED DESCRIPTION

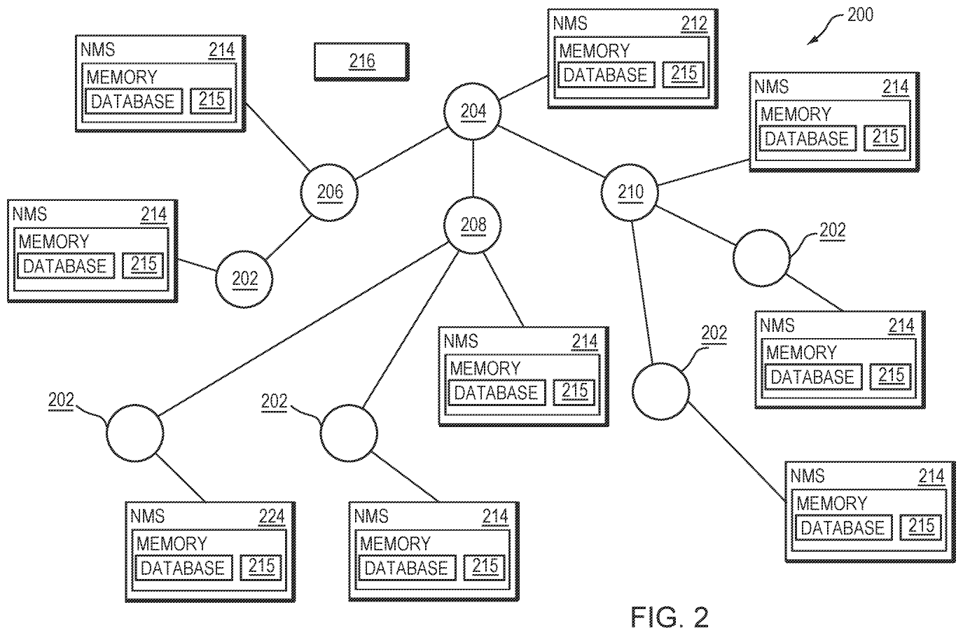

FIG. 2 conceptually illustrates an exemplary tree-based wireless network 200 comprising multiple network nodes 202, each including one parent node and one child node, for multicast routing of messages such as group packets across the network 200 in accordance herewith. For example, the parent node contained in node 204 may transmit a packet to the child nodes contained in nodes 206-210, and the child nodes contained in node 206 may receive the packet from the parent node contained in node 204. Each group packet may include a payload (e.g., a data packet) and routing information (such as target bit identifier vectors, target multicast group IDs, etc.) as described in PCT Publication No. WO 2020/095114, the entire contents of which are incorporated herein by reference. In addition, each group packet may be delivered via a special MAC layer frame (called “broadcast-with-ARQ frame”) that includes a string of bits representing the child nodes with which the parent node is associated as further described below.

In one embodiment, each network node 202 is a member of a transceiver “cell,” i.e., a discrete geographic region having fixed-location transceivers on, for example, lighting poles. A transceiver cell typically includes a “parent” node (e.g., the parent node contained in node 204) and one or more child nodes (e.g., the child nodes contained in nodes 206-210). In addition, each of the parent and child nodes may include one transceiver. The parent node is the “owner” of the cell node(s); a child node may be associated with only one parent node at a time. In one embodiment, the child nodes connect to their parent nodes via a “wireless tree branch.” The child node(s) in a cell are within the radio transmission range of the parent node and vice versa. Typically, the parent node and its child nodes are within a one-hop distance from each other. In each cell, a data packet can be delivered in a “downlinked” manner—i.e., from the parent node to its child node(s) (e.g., using broadcasting to all child nodes, multicasting to a selected subset of the child nodes, or unicasting to a specific child node) and/or in an “uplinked” manner—i.e., from a child node to its associated parent node using, for example, unicasting. If the data packet received by the child node does not originate from its associated parent node, the child node may discard the data packet. Similarly, if the data packet received by the parent node does not originate from one of its associated child nodes, the parent node may discard the data packet.

In various embodiments, each node acts as both a parent node and a child node. The parent node is an entity contained in a node that acts as a cell parent; and the other cell members are child nodes of the parent node located one hop away from the parent node. Similarly, the child node is an entity contained in a node and is a cell member “owned” by a parent in another node (e.g., one-hop distance away that acts as the parent).

The tree-based wireless network 200 may be constructed dynamically using one or more conventional protocols and algorithms. In one embodiment, the network 200 is constructed as a spanning tree that interconnects each network node via a unique path to the tree root node. The same path may connect the tree root node to a network node. In some embodiments, the network 200 is constructed as multiple spanning trees with appropriate identifiers per tree; each tree (and thereby its associated identifier) supports a unique path between the tree root node and a network node on that tree. Thus, a downlink data packet that “originates” from the tree root node (or a network management system) may traverse a path across the tree that includes a collection of the network nodes wirelessly interconnected from the parent node of one network node to a child node within the parent's cell (i.e., one hop away). The destination network node can be reached via multiple hops. For a given tree, the path from the root node to the target node is always the same; in other words, the path acts as a “virtual circuit” for a data packet to be delivered from the root node to a target node. The virtual circuit may maintain the in-order delivery of packets but does not guarantee that all delivered packets will reach the destination. Similarly, an uplink message may be delivered from a node to the root node via traversing a path therebetween. For example, assuming that nodes X, Y, and Z are along the path from the node originating the message to the tree root node, the uplink message may propagate along the wireless branches—i.e., from the originating child node (e.g., a child contained within node X) to its associated parent node (e.g., the parent contained within node Y), then internally propagate from the receiving parent node to the child node contained within the same node (e.g., node Y), then propagate further up to the parent node (e.g., contained within node Z) associated with the child node within node Y, and so on.

In various embodiments, each node contains two radio transceivers: one used by the parent within the node to send and/or receive data packets from the associated child node(s) and the other used by a child node within the node to send and/or receive data packets from the associated parent in another node. In addition, the tree structure may enable (i) each network node to deliver an uplink message directed to the tree root node (using e.g., MP2P) via a path determined by the tree structure, and (ii) the root node to deliver a downlink message to a selected node (using e.g., P2MP) via a path determined by the tree structure.

In addition, a collection of network nodes that have the same capability (e.g., equipped with a specific type of streetlight controller) may form a group. Each network node may be a member of (and thereby support) one or more groups. For example, a node may be a member of a citywide sensor group and a member of a group corresponding to a specific type of street lighting controller. The group members may be distributed across the tree structure in any fashion. For example, the group members may be concentrated in a geographical area (e.g., light controllers distributed in a specific neighborhood) or may be distributed citywide (e.g., air-quality sensors distributed across a city). In addition, the geographical location of one group may or may not overlap with that of another group. The tree-based network 200 can (but need not necessarily) be optimized for a certain group delivery. In one embodiment, the tree-based network 200 is constructed with various optimization rules without considering the possible group distributions.

In one embodiment, the wireless tree network 200 further includes a network management system (NMS) 212 to control one or more gateways that act as tree root nodes to the tree-based network. In addition, the NMS 212 may generate a message (e.g., a group packet) to the tree root(s) which then transmits the message to a specific network node or to a group of network nodes. In addition, the NMS 212 may be equipped with memory having a database to store information associated with the tree root nodes, network nodes and groups reachable via the corresponding tree roots. In some embodiments, each node 202 in the network 200 includes an individual NMS 214 having one or more modules 215 (e.g., a routing module) for performing various functions (such as generating a string of bits, configuring the packet and string of bits as a the broadcast-with-ARQ frame, delivering the broadcast-with-ARQ frame to all its associated child nodes (if broadcasting) or a selected group of its associated child nodes (if multicasting), receiving the broadcast-with-ARQ frame from its parent node, determining whether and when to transmit an ACK to its parent node, reporting the ACK at the determined time, etc.) as further described below. In addition, the NMS 214 may be equipped with memory having a database to store information associated with the parent node and child nodes (e.g., an identifier table including a list of link identifiers and optional MAC addresses corresponding to the child nodes).

The NMS 212/214 may include or consist essentially of a computing device, e.g., a server, which executes various program modules to perform methods in accordance with embodiments of the present invention. In addition, the memory may include or consist essentially of one or more volatile or non-volatile storage devices, e.g., random-access memory (RAM) devices such as DRAM, SRAM, etc., read-only memory (ROM) devices, magnetic disks, optical disks, flash memory devices, and/or other solid-state memory devices to store information associated with the tree root nodes and network nodes.

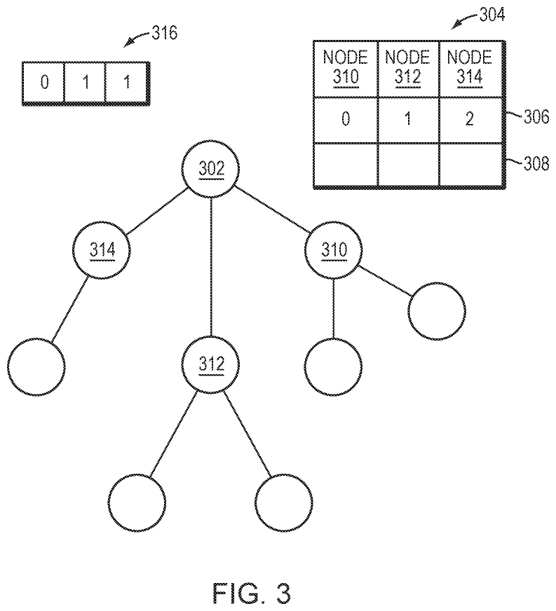

In various embodiments, the packet is delivered via a broadcast-with-ARQ frame 216. In addition, the broadcast-with-ARQ frame 216 may include a string of bits (or link identifiers); each bit corresponds to a child node associated with the parent node. For example, referring to FIG. 3, the network node 302 may include an identifier table 304 having a list of link identifiers 306 and optional MAC addresses 308 corresponding to the child nodes 310, 312, 314 associated therewith. The parent node 302 may assign the link identifier to each child node based on its order of association with the parent node. For example, assuming the child node 310 is associated with the parent node 302 prior to the child node 312, and the child node 312 is associated with the parent node 302 prior to the child node 314, the parent node 302 may assign the child nodes 310, 312, 314 with link identifiers of 0, 1, 2, respectively. When broadcasting or multicasting a packet to its child nodes, the NMS associated with the node 302 may generate a string 316 of bits based on the list of link identifiers 306 and subsequently configure the packet and the string of bits 316 as a broadcast-with-ARQ frame for delivery. In some embodiments, the number of bits in the string 316 is equal to the number of child nodes (or a selected group of child nodes) with which the parent node 302 is associated. In addition, the bit positions in the string may correspond to the link identifiers of the child nodes. For example, the string 316 may include 3 bits corresponding to the link identifiers of child nodes 310, 312, 314; the MSB position in the string may correspond to the highest number of the link identifiers (i.e., 2 corresponding to child node 314). As the bit position moves away from the MSB, the corresponding number of the link identifier may decrease until the LSB position corresponds to the lowest number of the link identifier (i.e., 0 corresponding to the child node 310). The parent node 302 may communicate the link identifiers (and, in one embodiment, their associated bit positions in the string 316) to the child nodes 310-314, which then store the information in the databases of their associated memory.

In one embodiment, the NMS associated with the parent node 302 may set the bit values in the string 316 to indicate whether the child nodes are required to report ACKs upon receipt of the broadcast-with-ARQ frame 216. For example, when the value in a bit position is set with a non-zero value (or “SET,” for ease of reference herein), the child node associated with the bit position is required to transmit an ACK to the transmitting parent node upon receiving the broadcast-with-ARQ frame 216. If, however, the value in a bit position of the string is set with the zero value (or “CLEAR,” for ease of reference herein), the child node associated with the bit position is not required to transmit an ACK to the parent node upon receiving the frame 216. For example, as depicted in FIG. 3, the bit values in the string 316 corresponding to the child nodes 310, 312, 314 are 1, 1, 0, respectively. Thus, upon receiving the frame 216, the child nodes 310, 312 are required to transmit ACKs to the parent node 302, while the child node 314 is not. The bit values in the string 316 may be set by the parent node for each broadcast or multicast of the packet. Alternatively, the bit values set for one broadcast/multicast may be utilized for the subsequent broadcast(s)/multicast(s).

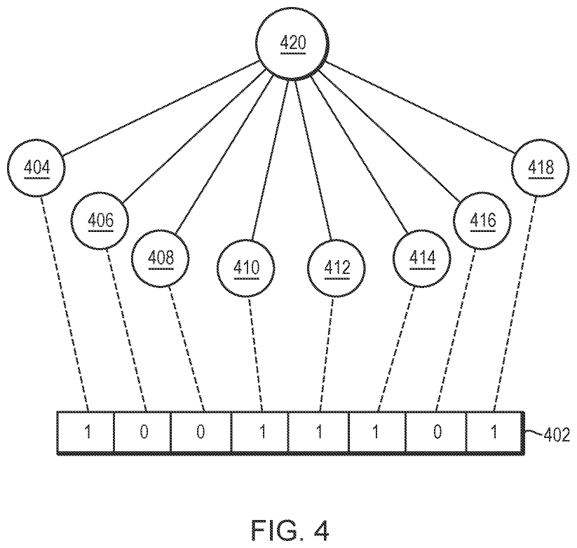

In various embodiments, all child nodes 310-314 communicate with the parent node 302 via the same radio channel (i.e., the parent node 302 and child nodes 310-314 are tuned to the same radio channel). Upon receiving the broadcast-with-ARQ frame 216, each child node immediately processes the frame 216 to acquire the bit value in the bit position associated with its link identifier and, based thereon, determine whether to report an ACK to the parent node 302. FIG. 4 depicts an exemplary string 402 contained in the broadcast-with-ARQ frame 216 having 8 bits of values, {1, 0, 0, 1, 1, 1, 0, 1}, corresponding to 8 child nodes 404-418 of a parent node 420. Upon receiving the broadcast-with-ARQ frame 216, the child nodes 404-418 may access their databases to retrieve their link identifiers (and, in one embodiment, their bit positions) and process the frame 216 to acquire the bit values in their associated bit positions. In this example, child nodes 404-418 determine that their bit positions in the string 402 are 1-8, respectively. Based on the bit values, child nodes 404, 410, 412, 414, 418 determine that they are required to report the ACKs to the parent node 420 as the bit values in their associated positions are SET, while child nodes 406, 408, 416 determine that they are not required to report the ACKs as the bit values in their associated positions are CLEAR

Because all reporting child nodes 404, 410, 412, 414, 418 communicate with the parent node 420 via the same channel, it may be desired to schedule the transmission time of the ACKs from the child nodes 404, 410, 412, 414, 418 so as to avoid collision. In one embodiment, transmission time of the ACKs from the child nodes is scheduled by the parent node 420 based on the string of bits transmitted therefrom. For example, the child nodes may transmit the ACKs in accordance with the order of their associated bit positions in the string 402. In FIG. 4, because child nodes 404, 410, 412, 414, 418 are associated with the first, fourth, fifth, sixth and eighth bit positions, respectively, in the string; transmission of the ACKs may start from the child node 404, followed by the child node 410, followed by the child node 412, followed by the child node 414, and finally followed by the child node 418.

Typically, the ACK reported from each child node is the same and has a fixed length, L. Thus, based on the data rate, R, of the radio channel, the time duration, t, for transmitting the ACK can be computed (e.g., t=LIR). In some embodiments, the time interval, Δt, between two successive ACKs from two reporting child nodes is also fixed. The interval, Δt, is typically set by the parent node and may be shorter than the interframe gap of a standard MAC layer within which the channel can be “idle” without being considered for usage by other irrelevant entities (as typically implemented in the CSMA/CA access scheme); this may advantageously allow the ACKs from different child nodes to be transmitted in succession with no interruption or collisions with other entities that attempt to access the same channel using the CSMA/CA channel access scheme.

In various embodiments, the child nodes compute their reporting times of the ACKs based on the transmission duration, t, of the ACK, the interval, Δt, between two successive ACKs, and their associated bit positions in the string 402. For example, an ACK duration, T, defined by the transmission duration, t, of the ACK and the interval, Δt, between successive ACKs can be first computed (e.g., T=t+Δt). Each reporting child node then determines the number, K, of bits whose value is non-zero (i.e., SET) that precede its associated bit position; this indicates that there are K child nodes required to transmit the ACKs prior to its reports. The reporting time for the child node can then be computed as T×K. For example, referring again to FIG. 4, K=0, 1, 2, 3, 4 for child nodes 404, 410, 412, 414, 418, respectively. Thus, the child node 404 may transmit the response ACK by the MAC layer immediately following receipt of the broadcast-with-ARQ frame 216 (following appropriate frame processing) such that there is no need to reacquire the radio channel for the ACK delivery. In addition, the child nodes 410, 412, 414, 418 may transmit their ACKs at time K, 2K, 3K, 4K, respectively. Because all child nodes are in synchronization per reception of the frame 216 from their parent node 420, this approach may advantageously avoid collision of the response ACKs from the reporting child nodes.

In some situations, one or more of the child nodes may not receive the broadcast-with-ARQ frame 216, but this does not affect transmissions of the ACKs from other child nodes. This is because the reporting time of the ACK for each node is based on the bit position that is associated with the link identifier of the child node; the reporting time is unaffected regardless whether and how many child nodes fail to report the ACKs resulting from missing receipt of the broadcast-with-ARQ frame 216.

Accordingly, various embodiments herein can efficiently and reliably route a packet to a target group of nodes in a tree-based wireless network by configuring a broadcast-with-ARQ frame to include the packet and a string of bits that represent the child nodes (or a selected group of the child nodes) which the parent node delivers the broadcast-with-ARQ frame to. Upon receipt of the frame, the child nodes can determine whether and when to report the ACKs to the parent node based on the contents of the string and the assigned link identifiers. As a result, this approach may efficiently utilize a single broadcast/multicast to transmit the packet to a target group of nodes, thereby avoiding the need of inefficient multiple unicasts. In addition, the delivery time of the packet may be beneficially shortened and the bandwidth gain may be increased with the number of the target child nodes (since the parent node delivers a broadcast frame instead of multiple unicast frames). Further, this approach may reliably deliver the packet as the parent node can expect an ACK from each targeted child node, and may employ standard ARQ procedure in case that the ACK is not received at the expected time. For example, the parent node may transmit the packet in a unicasting manner with acknowledgement to the child nodes that were expected to, but did not, respond with ACKs. Alternatively, the parent node may configure an updated broadcast-with-ARQ frame that has an updated list of child nodes (e.g., including the child nodes that were expected to, but did not, respond with ACKs) and broadcast the updated broadcast-with-ARQ frame to the child nodes on the updated list.

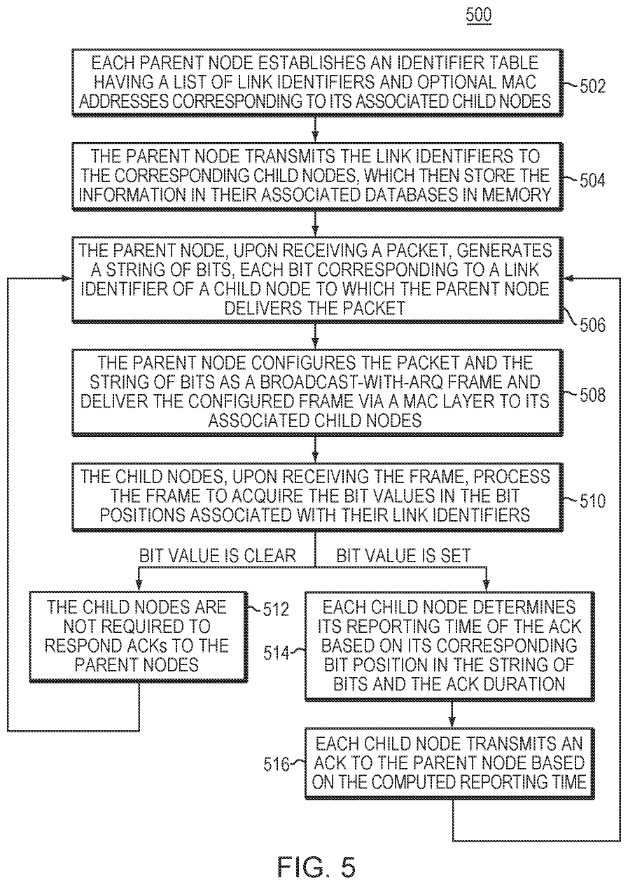

FIG. 5 illustrates an exemplary approach 500 for delivering a packet to a target group of nodes in a tree-based wireless network in accordance herewith. In a first step 502, the parent node establishes an identifier table 304 having a list of link identifiers and optional MAC addresses corresponding to its associated child nodes. In one embodiment, the link identifier corresponding to each child node is assigned based on its order of association with the parent node. In a second step 504, the parent node transmits the link identifiers to the corresponding child nodes, which then store the information in their associated databases in memory. In a third step 506, the parent node, upon receiving a packet, generates a string of bits, each bit corresponding to a link identifier of a child node to which the parent node delivers the packet. For example, the MSB position in the string may correspond to the highest number of the link identifiers; as the bit position moves away from the MSB, the corresponding number of the link identifier may decrease until the LSB position corresponds to the lowest number of the link identifier. Thus, the total number of bits in the string indicates the number of child nodes with which the parent node is associated and to which it transmits the packet. In a fourth step 508, the parent node may configure the packet and the string of bits as a broadcast-with-ARQ frame and deliver the configured frame via a MAC layer to its associated child nodes. Upon receiving the frame, the child nodes may process the frame to acquire the bit values in the bit positions associated with their link identifiers (step 510). If the bit values are CLEAR, the child nodes are not required to respond ACKs to the parent nodes (step 512); the child nodes may then act as a parent node to create another string of bits based on the link identifiers of it associated child nodes (step 506) and configure the received packet and the string of bits as a new broadcast-with-ARQ frame and deliver the newly configured frame via a MAC layer to its associated child nodes (step 508). If, however, the bit values are SET, the child nodes are required to report ACKs to the parent nodes. In one embodiment, each child node determines its reporting time of the ACK based on its corresponding bit position in the string of bits and the ACK duration, T (step 514). For example, if there are K bits whose value is SET preceding the bit position associated the child node, the child node is expected to report the ACK at a time K×T. Subsequently, each child node can transmit an ACK to the parent node based on the computed reporting time (step 516). In addition, the child nodes may, again, act as a parent node to create a string of bits based on the link identifiers of its associated child nodes (step 506) and configure the received packet and the string of bits as a new broadcast-with-ARQ frame and deliver the newly configured frame to its associated child nodes (step 508). Steps 502-516 may be performed by each node along the path to the target node(s).

It should be noted that the broadcast-with-ARQ frame 216 and the string of bits described above are implemented only when the packet is delivered in a broadcasting or multicasting manner. If the packet is delivered in a unicasting manner, the standard MAC procedures can be implemented. In addition, the total time that the parent node may wait for receiving the ACKs before transmitting another message may depend on the number of the target child nodes which are required to report. Further, the approaches described herein for efficiently and reliably delivering a packet to a target group of nodes can be implemented in any wireless network that has an underlying logical tree-based structure. In addition, these approaches do not require the tree to be static. If the network is dynamic, the tree structure may occasionally change; the approaches described herein can automatically adapt to the new network topology. For example, as described above, when a new child node joins the network and needs to broadcast/multicast a packet to its associated child nodes, the parent node which the new child node is associated with may assign a new link identifier to the new child node and may include the new link identifier when creating a new string of bits for delivering a new packet.

The NMS 212/214 described herein may include one or more modules (e.g., a routing module 215) implemented in hardware, software, or a combination of both for performing the functions described above (e.g., steps in FIG. 5). For embodiments in which the functions are provided as one or more software programs, the programs may be written in any of a number of high level languages such as PYTHON, FORTRAN, PASCAL, JAVA, C, C++, C#, BASIC, various scripting languages, and/or HTML. Additionally, the software can be implemented in an assembly language directed to the microprocessor resident on a target computer; for example, the software may be implemented in Intel 80x86 assembly language if it is configured to run on an IBM PC or PC clone. The software may be embodied on an article of manufacture including, but not limited to, a floppy disk, a jump drive, a hard disk, an optical disk, a magnetic tape, a PROM, an EPROM, EEPROM, field-programmable gate array, or CD-ROM. Embodiments using hardware circuitry may be implemented using, for example, one or more FPGA, CPLD or ASIC processors.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A method of routing a packet in a network comprising a plurality of cells each supporting communication among a plurality of transceiver nodes therein and being capable of receiving and transmitting the packet, each cell comprising a parent node and at least one child node, the method comprising:
(a) for each cell, establishing and storing an identifier table comprising at least one link identifier associated with the at least one child node;
(b) upon receiving a packet, generating a string of at least one bit based at least in part on the at least one link identifier; and
(c) transmitting the packet and the string to the at least one child node.

2. The method of claim 1, further comprising receiving an acknowledgement (ACK) from the at least one child node.

3. The method of claim 2, wherein the at least one child node transmits the ACK only when a value of the at least one bit is non-zero.

4. The method of claim 1, wherein the pack and the string in step (c) are transmitted in a broadcasting manner.

5. The method of claim 1, wherein at least one of the cells comprises a plurality of child nodes, the identifier table in said at least one of the cells comprises a plurality of link identifiers, each associated with one of the plurality of child nodes, and the string generated in step (b) comprises a plurality of bits, each corresponding to one of the link identifiers.

6. The method of claim 5, wherein a most-significant bit (MSB) position in the string corresponds to a highest number of the link identifiers, and as a bit position moves away from the MSB, the corresponding number of the link identifier decreases.

7. The method of claim 6, further comprising receiving at least some ACKs from at least some of the plurality of child nodes, wherein each of the at least some of the child nodes transmits the ACK at a transmitting time based at least in part on the bit position associated with its link identifier in the string.

8. The method of claim 7, wherein the transmitting time associated with each of the at least some of the child nodes is further based at least in part on a transmission duration of the ACK and a time interval between two successive ACKs.

9. The method of claim 8, wherein the transmitting time associated with each of the at least some of the child nodes satisfies an equation:
transmitting time=(t+Δt)×K
where t denotes the transmission duration of the ACK, Δt denotes the time interval between two successive ACKs, and K denotes a number of bits having non-zero values and preceding the bit position associated with said each of the at least some of the child nodes in the string.

10. The method of claim 8, further comprising, upon determining that the ACK from one of the at least some of the child nodes is not received at the transmitting time associated therewith, retransmitting the packet to said one of the at least some of the child nodes.

11. A router for handling packets in a network, the router comprising:
memory for storing an identifier table comprising a plurality of link identifiers and a plurality of child nodes, each of the link identifiers being associated with one of the child nodes of the router; and
a routing module configured to:
(a) upon receiving a packet, generate a string of at least one bit based at least in part on one of the link identifiers; and
(b) transmit the packet and the string to the child node associated with the one of the link identifiers.

12. The router of claim 11, wherein the routing module is further configured to receive an ACK from the child node.

13. The router of claim 12, wherein the child node transmits the ACK only when a value of the at least one bit is non-zero.

14. The router of claim 11, wherein the routing module is further configured to transmit the pack and string in a broadcasting manner.

15. The router of claim 11, wherein the string generated in step (a) comprises a plurality of bits, each corresponding to one of the link identifiers.

16. The router of claim 15, wherein a most-significant bit (MSB) position in the string corresponds to a highest number of the link identifiers, and as a bit position moves away from the MSB, the corresponding number of the link identifier decreases.

17. The router of claim 16, wherein the routing module is further configured to receive at least some ACKs from at least some of the plurality of child nodes, wherein each of the at least some of the child nodes transmits the ACK at a transmitting time based at least in part on the bit position associated with its link identifier in the string.

18. The router of claim 17, wherein the transmitting time associated with each of the at least some of the child nodes is further based at least in part on a transmission duration of the ACK and a time interval between two successive ACKs.

19. The router of claim 18, wherein the transmitting time associated with each of the at least some of the child nodes satisfies an equation:
transmitting time=(t+Δt)×K
where t denotes a transmission duration of the ACK, Δt denotes the time interval between two successive ACKs, and K denotes a number of bits having non-zero values and preceding the bit position associated with said each of the at least some of the child nodes in the string.

20. The router of claim 18, wherein the routing module is further configured to, upon determining that the ACK from one of the at least some of the child nodes is not received at the transmitting time associated therewith, retransmit the packet to said one of the at least some of the child nodes.
